(19) United States
(12) Patent Application Publication
(10) Pub. No.: US 2022/0193621 A1
(43) Pub. Date: Jun. 23, 2022

(54) ULTRASOUND STIRRING DEVICE

(71) Applicant: DONGGUAN AMERISUN SCIENCE AND TECHNOLOGY CO., LTD., DONGGUAN (CN)

(72) Inventor: XIANQIONG CAI, DONGGUAN (CN)

(21) Appl. No.: 17/130,014

(22) Filed: Dec. 22, 2020

(51) Int. Cl. B01F 11/02; B01F 11/00; B01F 15/00

(52) U.S. Cl. CPC B01F 11/0266; B01F 11/0011; B01F 11/0291; B01F 15/00519; B01F 15/00396; B01F 15/00155; B01F 15/00175

(57) ABSTRACT

The present invention comprises an ultrasound stirring device. The ultrasound stirring device includes an inner container body configured for accommodating solution, an outer container body accommodating the inner container body, an ultrasound generator located between the inner container body and the outer container body, a mounting base located a side of the outer container body far away from the inner container body and configured for supporting the outer container body, a first circuit board including a control circuit configured for controlling the ultrasound generator generate ultrasound to stir the solution, and a battery configured for supplying the first circuit board.

### FIELD OF THE INVENTION

The present disclosure relates to technical field of stirring devices, and more particularly to an ultrasound stirring device.

### BACKGROUND OF THE INVENTION

As we all know, in our daily life, coffee, milk or sugar water and other solution that needs to be stirred fully by spoon and other objects. Traditional stirring is not only time-consuming and laborious, but also has a risk of virus transmission (such as new coronavirus transmission).

### SUMMARY OF THE INVENTION

In order to overcome the disadvantage of the existing stirring device, the present disclosure provides an ultrasound stirring device.

The present disclosure adopts the following technical solution: an ultrasound stirring device including an inner container body configured for accommodating a solution, an outer container body accommodating the inner container body, an ultrasound generator located between the inner container body and the outer container body, a mounting base located a side of the outer container body far away from the inner container body and configured for supporting the outer container body, a first circuit board including control circuit configured for controlling the ultrasound generator generate ultrasound to stir the solution and a battery configured for supplying the first circuit board.

Furthermore, the ultrasound stirring device further includes a semiconductor heating and cooling module electrically connected to the control circuit, and the control circuit is also configured for controlling the semiconductor heating and cooling module heat or cool the solution.

Furthermore, the ultrasound stirring device further includes a temperature sensor connected to the control circuit and a display screen, the control circuit is configured for controlling the semiconductor heating and cooling module according to a temperature signal from the temperature sensor, and the display screen is configured for display a temperature according to the temperature signal.

Furthermore, the ultrasound stirring device further includes a water level sensor configured for detecting a water level of the solution, when the water level of the solution is less than or equal to a predetermined water level, the control circuit control the ultrasound generator stop working.

Furthermore, the ultrasound stirring device further includes a first switch and a second switch, the first switch is configured for switching on the ultrasound stirring device and switching off the ultrasound stirring device, and the second switch is configured for adjusting a strength of the ultrasound and a length of time of the ultrasound.

Furthermore, the ultrasound stirring device further includes a wireless charging receiver electrically connected to the battery, and the wireless charging receiver is configured for detecting a charging signal and charging the battery according to the charging signal.

Furthermore, the charging signal ranges from 5 volts to 24 volts.

Furthermore, the ultrasound stirring device further includes a wireless charging emitter and a converter electrically connected to the wireless charging emitter, and the wireless charging emitter is configured for receiving a power voltage from the converter and outputting the charging signal to the wireless charging receiver.

Furthermore, the converter is a selected one from the group of a DC to DC converter and an AC to DC converter.

Furthermore, the ultrasound stirring device further includes a connection element electrically connect to the converter, and the connection element is selected one from the group of an USB port and a power plug.

Furthermore, the ultrasound stirring device includes a charging base located at a side of the mounting base far away from the outer container body and configured for charging the battery.

Furthermore, the charging base includes a housing, a second circuit board located in the housing and at least one connection element, an end of the connection element is electrically connected with the second circuit board, the other end of the connection element passes though the housing and is configured for electrically connecting with the first circuit board, and the second circuit board is configured for charging the battery via the connection element and the first circuit board.

Furthermore, the housing includes a bottom plate, a top plate facing with the bottom plate and a connection plate connected between the bottom plate and the top plate, the second circuit board is located between the bottom plate and the top plate, and the connection element passes though the top plate so as to connect with the first circuit board.

Furthermore, a surface of the top plate adjacent to the mounting base includes a first groove, the mounting base includes a first bottom board and a first sidewall connected an edge of the first bottom board, the first sidewall and the first bottom board form an accommodating space, the first circuit board and the battery are located in the accommodating space, the first bottom board is located in the first groove, and the connection element is configured for passing through a first hole of the top plate and a second hole of the first bottom board so as to electrically connect with the first circuit board.

Furthermore, the outer container body includes a second bottom board and a second sidewall connected an edge of the second bottom board, the inner container body includes a third bottom board and a third sidewall connected an edge of the third bottom board, and the ultrasound generator is located between the second bottom board and the third bottom board.

Furthermore, the second bottom board includes an opening located at a middle region of the second bottom board, the ultrasound stirring device further includes a plurality of fixing elements, and each fixing element is connected between the second bottom board and the ultrasound generator.

Furthermore, a surface of the third bottom board adjacent to the second bottom board includes a second groove, and the ultrasound generator is located in the second groove.

Furthermore, an end of the second sidewall far away from the second bottom board is connected with an end of the third sidewall far away from the third bottom board, the ultrasound stirring device further includes a first cover, and the first cover is configured for covering the end of the inner container body and the end of the outer container body.

Furthermore, the ultrasound stirring device further includes a second cover, the first cover includes a though hole, the second cover is rotatably connected with a side of the first cover far away from the inner container body, and the second cover is configured for sealing the though hole.

Furthermore, the ultrasound stirring device further includes a seal element, and the seal element is sandwiched between the first cover and the inner container body.

The ultrasound stirring device is used to stir coffee, milk and other solution with ultrasound, which can not only reduce the stirring tools and stirring process, but also ensure that the solution is less contacted with other objects, so as to ensure hygienic and healthy.

### BRIEF DESCRIPTION OF THE DRAWINGS

For the purpose of a clearer description of the embodiments in this application or technical solutions in prior art, below is a brief introduction of the attached drawings needed to be used in the description of the embodiments or prior art. Apparently, the attached drawings in the following description are only some embodiments indicated in the present application. For ordinary skill in the art, they may obtain other drawings according to these attached drawings without any innovative laboring.

The present disclosure will be further described with reference to the attached drawings and the embodiments hereunder.

FIG. 1 is a schematic diagram of an ultrasound stirring device according to one embodiment of the present disclosure;

FIG. 2 is an explosive view of the ultrasound stirring device of FIG. 1;

FIG. 3 is another explosive view of the ultrasound stirring device of FIG. 1;

FIG. 4 is a cross-section view of the ultrasound stirring device of FIG. 1 taken along line IV-IV; and

FIG. 5 is a circuit block diagram of the ultrasound stirring device of FIG. 1.

### DETAILED DESCRIPTION OF THE ILLUSTRATED EMBODIMENT

In order to provide a clear understanding of the objects, features, and advantages of the embodiments, the following are detailed and complete descriptions to the technological solutions adopted in the embodiments. Obviously, the descriptions are part of the whole embodiments. The other embodiments which are not processed creatively by technicians of ordinary skills in the field are under the protection of this disclosure. The same is given with reference to the drawings and specific embodiments. It should be noted that non-conflicting embodiments in the disclosure and the features in the embodiments may be combined with each other without conflict.

In the following description, numerous specific details are set forth in order to provide a full understanding of the disclosure. The disclosure may be practiced otherwise than as described herein. The following specific embodiments are not to limit the scope of the disclosure.

Unless defined otherwise, all technical and scientific terms herein have the same meaning as used in the field of the art as generally understood. The terms used in the disclosure are to describe particular embodiments and are not intended to limit the disclosure.

The disclosure, referencing the accompanying drawings, is illustrated by way of examples and not by way of limitation. It should be noted that references to “an” or “one” embodiment in this disclosure are not necessarily to the same embodiment, and such references mean “at least one.”

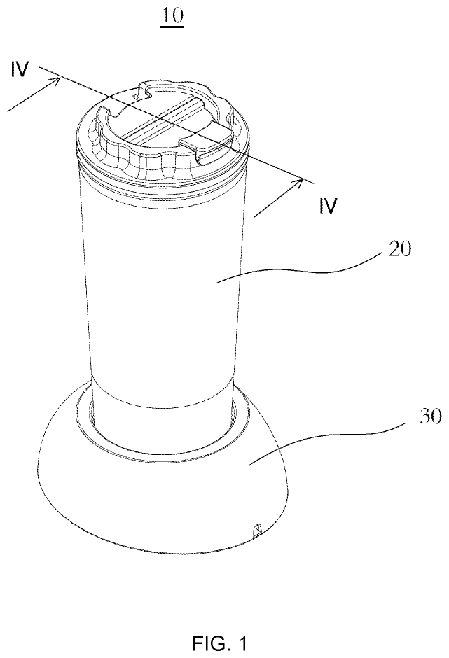

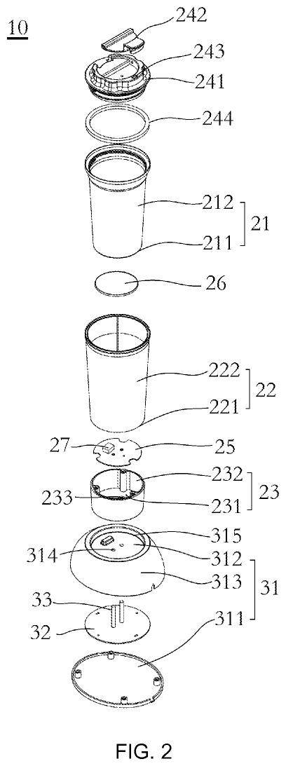

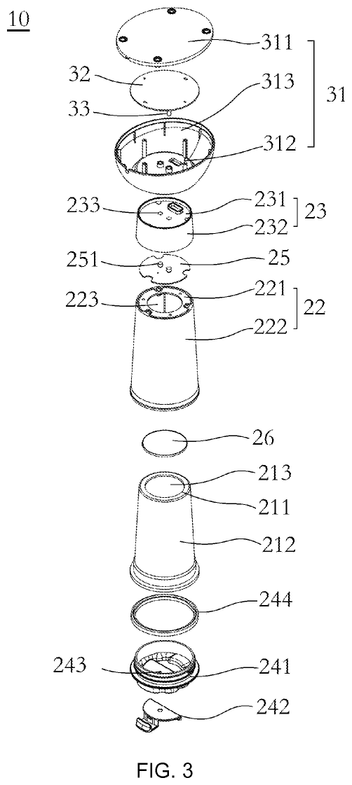

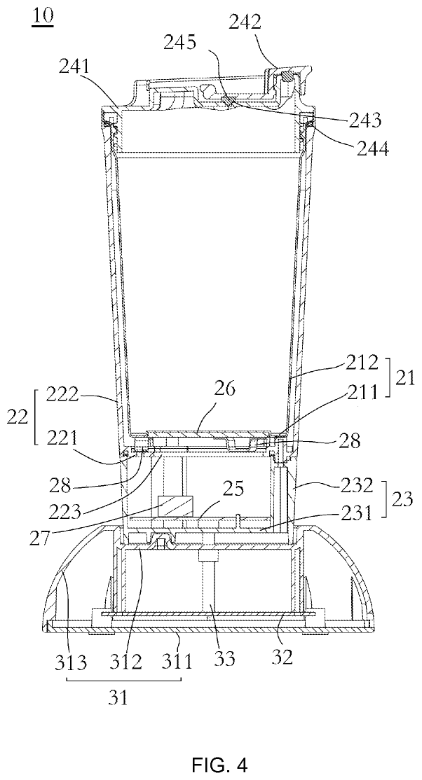

In view of the disadvantage of the existing storage products, the present disclosure provides a ultrasound stirring device. Referring to FIGS. 1-5, the ultrasound stirring device 10 includes an ultrasound stirring container 20 and a charging base 30 configured for supporting and charging the ultrasound stirring container 20.

The ultrasound stirring container 20 includes an inner container body 21, an outer container body 22, a mounting base 23, a first cover 241, a second cover 242, a seal element 244, a first circuit board 25, an ultrasound generator 26, a battery 27 and fixing elements 28.

The inner container body 21 is configured for accommodating solution, such as coffee, milk, or other food. The outer container body 22 is configured for accommodating the inner container body 21. The ultrasound generator 26 is located between the inner container body 21 and the outer container body 22. The mounting base 23 is located a side of the outer container body 22 far away from the inner container body 21 and configured for supporting the outer container body 22. The first circuit board 25 includes a control circuit 251 configured for controlling the ultrasound generator 26 generate ultrasound to stir the solution in the inner container body 21. The battery 27 is configured for supplying the first circuit board 25.

The charging base 30 is located at a side of the mounting base 23 far away from the outer container body 22 and configured for charging the battery 27. The charging base 30 includes a housing 31, a second circuit board 32 located in the housing 31 and connection elements 33. An end of the connection element 33 is electrically connected with the second circuit board 32, the other end of the connection element 33 passes though the housing 31 and is configured for electrically connecting with the first circuit board 25, and the second circuit board 32 is configured for charging the battery 27 via the connection element 33 and the first circuit board 25.

The housing 31 includes a bottom plate 311, a top plate 312 facing with the bottom plate 311 and a connection plate 313 connected between the bottom plate 311 and the top plate 312. The second circuit board 32 is located between the bottom plate 311 and the top plate 312, and the connection element 33 passes though the top plate 312 so as to connect with the first circuit board 25.

A surface of the top plate 311 adjacent to the mounting base 23 includes a first groove 315. The mounting base 23 includes a first bottom board 231 and a first sidewall 232 connected an edge of the first bottom board 231. The first sidewall 232 and the first bottom board 231 form an accommodating space, and the first circuit board 25 and the battery 27 are located in the accommodating space. The first bottom board 231 is located in the first groove 315, and the connection element 33 is configured for passing through a first hole 314 of the top plate 311 and a second hole 233 of the first bottom board 231 so as to electrically connect with the first circuit board 25. The first circuit board 25 can include connection terminals 251, and the connection terminal 251 is configured to contact the connection element 33 so as to electrically connect with the connection element 33.

The outer container body 22 includes a second bottom board 221 and a second sidewall 222 connected an edge of the second bottom board 221. The inner container body 21 includes a third bottom board 211 and a third sidewall 212 connected an edge of the third bottom board 211, and the ultrasound generator 26 is located between the second bottom board 221 and the third bottom board 211.

The second bottom board 221 includes an opening 223 located at a middle region of the second bottom board 221. The fixing element 28 is connected between the second bottom board 221 and the ultrasound generator 26 so as to fix the ultrasound generator 26. A surface of the third bottom board 211 adjacent to the second bottom board 221 includes a second groove 213, and the ultrasound generator 26 is located in the second groove 213.

An end of the second sidewall 222 far away from the second bottom board 221 is connected with an end of the third sidewall 212 far away from the third bottom board 211. The first cover 241 is configured for covering the end of the inner container body 21 and the end of the outer container body 22. The first cover 241 includes a through hole 243, the second cover 242 is rotatably connected with a side of the first cover 241 far away from the inner container body 21, and the second cover 242 is configured for sealing the through hole 243. The second cover 242 includes a protrusion 245 corresponding to the through hole 243, and the protrusion 245 can be disposed at the through hole 243 so as to seal the inner container body 21. In addition, the seal element 244 is sandwiched between the first cover 241 and the inner container body 21 and configured for sealing the inner container body 21.

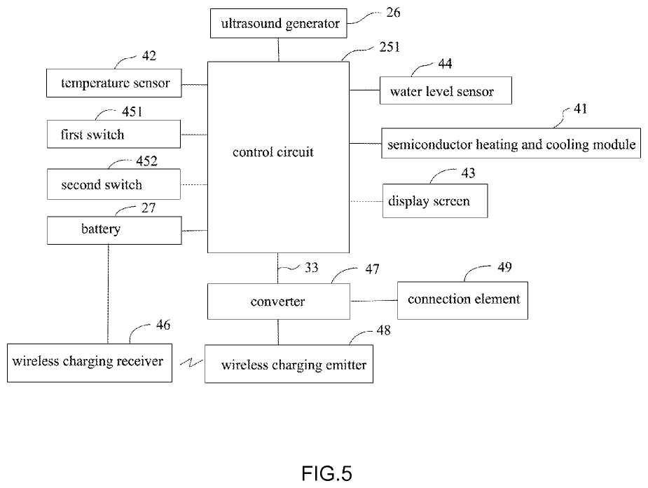

Referring to FIG. 5, FIG. 5 is a circuit block diagram of the ultrasound stirring device of FIG. 1. The ultrasound stirring device 10 further includes a semiconductor heating and cooling module 41, a temperature sensor 42, a display screen 43, a water level sensor 44, a first switch 451, a second switch 452, a wireless charging receiver 46, a wireless charging emitter 47, a converter 48 and a connection element 49.

The semiconductor heating and cooling module 41 can be located between the inner container body 21 and the outer container body 22. The semiconductor heating and cooling module 41 is electrically connected to the control circuit 251, such that the control circuit 251 can control the semiconductor heating and cooling module 41 heat or cool the solution in the inner container body 21.

The temperature sensor 42 can be located between the inner container body 21 and the outer container body 22. The temperature sensor 42 and the display screen 43 can be electrically connected to the control circuit 251. The control circuit 251 can be configured for controlling the semiconductor heating and cooling module 41 according to a temperature signal from the temperature sensor 42, and the display screen 43 is configured for display a temperature according to the temperature signal under controls of the control circuit 251.

The water level sensor 44 can be located in the inner container body 21, and the water level sensor 44 is configured for detecting a water level of the solution in the inner container body 21. When the water level of the solution is less than or equal to a pre-determined water level, the control circuit 251 control the ultrasound generator stop working so as to protect the ultrasound generator 26.

The first switch 451 and the second switch 452 are electrically connected to the control circuit 251 respectively. The first switch 451 is configured for switching on the ultrasound stirring device 10 and switching off the ultrasound stirring device 10, and the second switch 452 is configured for adjusting a strength of the ultrasound and a length of time of the ultrasound so as to control stirring strength and strength time.

The wireless charging receiver 46 can be located at the mounting base 23 and electrically connected to the battery 27, and the wireless charging receiver 46 is configured for detecting a charging signal and charging the battery 27 according to the charging signal. In one embodiment, the charging signal ranges from 5 volts to 24 volts.

The wireless charging emitter 47 and the converter 48 can be located at the charging base 30. The converter 48 can be disposed on the second circuit board 32. The wireless charging emitter 47 is electrically connected to the converter 48, and the converter 48 is electrically connected to the control circuit 251 via the connection element 33. The converter 48 can supply the control circuit 251 and charging the battery 27 via the connection element 33. The wireless charging emitter 47 is configured for receiving a power voltage from the converter 48 and outputting the charging signal to the wireless charging receiver 46.

In one embodiment, the converter 48 is a DC to DC converter, and the connection element 49 is an USB port. The connection element 49 is electrically connected to the converter 48 and is also configured for connecting other device to receive a DC power signal.

In other embodiment, the converter 48 can be an AC to DC converter, and the connection element 49 can include a power plug, the power plug is electrically connected to the converter 48 and is also configured for insert into a socket to receive an AC power signal.

It can be understood, the ultrasound stirring device 10 is used to stir coffee, milk and other solution with ultrasound, which can not only reduce the stirring tools and stirring process, but also ensure that the solution is less contacted with other objects, so as to ensure hygienic and healthy.

Finally, it should be noted that above embodiments are merely used for illustrating the technical solutions of the disclosure, rather than limiting the disclosure. Although the disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to a part of technical features thereof; and these modifications or substitutions do not make the essence of the corresponding technical solutions depart from the spirit and scope of the technical solutions of the respective embodiments of the disclosure.

What is claimed as new and desired to be protected by Letters Patent, is:

1. An ultrasound stirring device, comprising:
an inner container body configured for accommodating solution;
an outer container body accommodating the inner container body;
an ultrasound generator located between the inner container body and the outer container body;
a mounting base located a side of the outer container body far away from the inner container body and configured for supporting the outer container body;
a first circuit board comprising a control circuit configured for controlling the ultrasound generator generate ultrasound to stir the solution; and
a battery configured for supplying the first circuit board.

2. The ultrasound stirring device of claim 1, wherein:
the ultrasound stirring device further comprises a semiconductor heating and cooling module electrically connected to the control circuit, and the control circuit is also configured for controlling the semiconductor heating and cooling module heat or cool the solution.

3. The ultrasound stirring device of claim 2, wherein:
the ultrasound stirring device further comprises a temperature sensor connected to the control circuit and a display screen, the control circuit is configured for controlling the semiconductor heating and cooling module according to a temperature signal from the temperature sensor, and the display screen is configured for display a temperature according to the temperature signal.

4. The ultrasound stirring device of claim 2, wherein:
the ultrasound stirring device further comprises a water level sensor configured for detecting a water level of the solution, when the water level of the solution is less than or equal to a predetermined water level, the control circuit control the ultrasound generator stop working.

5. The ultrasound stirring device of claim 1, wherein:
the ultrasound stirring device further comprises a first switch and a second switch, the first switch is configured for switching on the ultrasound stirring device and switching off the ultrasound stirring device, and the second switch is configured for adjusting a strength of the ultrasound and a length of time of the ultrasound.

6. The ultrasound stirring device of claim 1, wherein:
the ultrasound stirring device further comprises a wireless charging receiver electrically connected to the battery, and the wireless charging receiver is configured for detecting a charging signal and charging the battery according to the charging signal.

7. The ultrasound stirring device of claim 6, wherein:
the charging signal ranges from 5 volts to 24 volts.

8. The ultrasound stirring device of claim 6, wherein:
the ultrasound stirring device further comprises a wireless charging emitter and a converter electrically connected to the wireless charging emitter, and the wireless charging emitter is configured for receiving a power voltage from the converter and outputting the charging signal to the wireless charging receiver.

9. The ultrasound stirring device of claim 8, wherein:
the converter is a selected one from the group of a DC to DC converter and an AC to DC converter.

10. The ultrasound stirring device of claim 8, wherein:
the ultrasound stirring device further comprises a connection element electrically connected to the converter, and the connection element is selected one from the group of an USB port and a power plug.

11. The ultrasound stirring device of claim 1, wherein:
the ultrasound stirring device further comprises a charging base located at a side of the mounting base far away from the outer container body and configured for charging the battery.

12. The ultrasound stirring device of claim 11, wherein:
the charging base comprises a housing, a second circuit board located in the housing and at least one connection element, an end of the connection element is electrically connected with the second circuit board, the other end of the connection element passes though the housing and is configured for electrically connecting with the first circuit board, and the second circuit board is configured for charging the battery via the connection element and the first circuit board.

13. The ultrasound stirring device of claim 12, wherein:
the housing comprises a bottom plate, a top plate facing with the bottom plate and a connection plate connected between the bottom plate and the top plate, the second circuit board is located between the bottom plate and the top plate, the connection element passes though the top plate so as to connect with the first circuit board.

14. The ultrasound stirring device of claim 13, wherein:
a surface of the top plate adjacent to the mounting base comprises a first groove, the mounting base comprises a first bottom board and a first sidewall connected an edge of the first bottom board, the first sidewall and the first bottom board form an accommodating space, the first circuit board and the battery are located in the accommodating space, the first bottom board is located in the first groove, and the connection element is configured for passing through a first hole of the top plate and a second hole of the first bottom board so as to electrically connect with the first circuit board.

15. The ultrasound stirring device of claim 14, wherein:
the outer container body comprises a second bottom board and a second sidewall connected an edge of the second bottom board, the inner container body comprises a third bottom board and a third sidewall connected an edge of the third bottom board, and the ultrasound generator is located between the second bottom board and the third bottom board.

16. The ultrasound stirring device of claim 15, wherein:
the second bottom board comprises an opening located at a middle region of the second bottom board, the ultrasound stirring device further comprises a plurality of fixing elements, and each fixing element is connected between the second bottom board and the ultrasound generator.

17. The ultrasound stirring device of claim 16, wherein:
a surface of the third bottom board adjacent to the second bottom board comprises a second groove, and the ultrasound generator is located in the second groove.

18. The ultrasound stirring device of claim 16, wherein:
an end of the second sidewall far away from the second bottom board is connected with an end of the third sidewall far away from the third bottom board, the ultrasound stirring device further comprises a first cover, and the first cover is configured for covering the end of the inner container body and the end of the outer container body.

19. The ultrasound stirring device of claim 18, wherein:
the ultrasound stirring device further comprises a second cover, the first cover comprises a though hole, the second cover is rotatably connected with a side of the first cover far away from the inner container body, and the second cover is configured for sealing the though hole.

20. The ultrasound stirring device of claim 18, wherein:
the ultrasound stirring device further comprises a seal element, and the seal element is sandwiched between the first cover and the inner container body.
